(19) United States
(12) Patent Application Publication
(10) Pub. No.: US 2026/0173038 A1
(43) Pub. Date: Jun. 18, 2026

(54) ENHANCEMENT OF UPLINK TRANSMISSIONS

(71) Applicant: Nokia Technologies Oy, Espoo (FI)

(72) Inventors: Claudio ROSA, Randers NV (DK); Guillermo POCOVI, Aalborg (DK); Amol DHERE, Gistrup (DK); Alessio MARCONE, Munich (DE); Perttu Aukusti MELLA, Lepsama (FI)

(21) Appl. No.: 19/123,738

(22) PCT Filed: Oct. 28, 2022
(86) PCT No.: PCT/EP2022/080164

§ 371 Date: Apr. 23, 2025

(51) Int. Cl. H04W 72/04; H04W 72/23

(52) U.S. Cl. CPC H04W 72/04; H04W 72/23

(57) ABSTRACT

There are provided measures for enhancement of uplink transmissions. Such measures exemplarily comprise, at a terminal, transmitting a first message indicative of the terminal's capability of half-symbol transmission, receiving a configuration for half-symbol transmission, and transmitting, based on said configuration, a signal in a part of a symbol located in a specific period between a first resource and a second resource.

### FIELD

Various example embodiments relate to enhancement of uplink transmissions. More specifically, various example embodiments exemplarily relate to measures (including methods, apparatuses and computer program products) for realizing enhancement of uplink transmissions.

### BACKGROUND

The present specification generally relates to an improved exploitation of radio resources.

3^{rd} Generation Partnership Project (3GPP) New Radio (NR) currently supports two duplexing modes: Frequency division duplex (FDD) for paired bands and time division duplex (TDD) for unpaired bands.

In TDD, the time domain resource is split between downlink (DL) and uplink (UL). In TDD, allocation of uplink resources for a limited time duration would result in reduced uplink coverage, increased latency, and reduced uplink capacity.

There is thus a push on evolution of duplexing operation in NR that addresses some of the challenges above. An approach is to allow simultaneous DL transmission (Tx) and UL reception (Rx) on different physical resource blocks (PRB) within an unpaired wideband NR cell.

FIG. 7 shows a schematic diagram of example duplex modes and respective resource partitioning, and in particular illustrates frequency-time resource partitioning in case of FDD, in case of TDD, and in case of flexible duplexing (FDU), also mentioned as cross-division duplexing (xDD) or subband non-overlapping full duplex (SBFD). SBFD allows for simultaneous DL transmission and UL reception on different PRBs within an unpaired wideband NR cell.

In NR, a user equipment's (UE) timing of its UL transmission is offset with respect to its DL reception by an offset known as the timing advance (TA).

FIG. 8 is a schematic diagram illustrating the timing advance (in NR).

The TA (T_{TA}) is configured by the network as a sum of a UE specific TA command (N_{TA}*T_{c}) (absolute or relative) and a cell specific TA offset (N_{TA,offset}*T_{c}):

$${T}_{TA} = ( {N}_{TA} + {N}_{TA , offset} ) {T}_{c}$$

In other words, the UE determines the TA as the sum of the cell specific TA offset and the UE specific TA command (absolute or relative) which is indicated via either a random access response (RAR) message (N_{TA}=T_{A}· 16·64/2^{μ}, with T_{A}=0, 1, 2, . . . , 3846) or in a medium access control control element (MAC CE) (N_{TA_new}=N_{TA_old}+ (T_{A}−31)·16·64/2^{μ}, with T_{A}=0, 1, 2, . . . , 63).

The cell specific TA offset (N_{TA,offset}) can be configured by the network in system information block 1 (SIB1) (n-TimingAdvanceOffset).

If n-TimingAdvanceOffset is not provided by the serving cell, the UE assumes TA offset in the following table:

| Frequency range and band of cell | N_{TA offset} |
|---|---|
| used for uplink transmission | (Unit: Tc) |
| FR1 FDD or TDD band with neither E-UTRA- | 25600 (Note 1) |
| NR nor NB-IoT-NR coexistence case | |
| FR1 FDD band with E-UTRA-NR and/or | 0 (Note 1) |
| NB-IoT-NR coexistence case | |
| FR1 TDD band with E-UTRA-NR and/or | 39936 (Note 1) |
| NB-IoT-NR coexistence case | |
| FR2 | 13792 |

(Note 1):
The UE identifies N_{TA offset} based on the information n-TimingAdvanceOffset as specified in TS 38.331. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 and the value 39936 of N_{TA offset} can also be provided for a FDD serving cell.
Note 2:
Void

As can be learned from the first row, in case of TDD in FR1 with no LTE-NR coexistence, the value of the cell specific TA offset is 25600*Tc=13.03 μs.

Tc is 0.509 ns.

While the UE specific TA is typically used to compensate for the propagation delay so that reception of UL signals from different UEs can be synchronized, the cell specific TA offset is introduced to shift the relative timing between UL and DL so that the system overhead that is necessary to allow a half-duplex UE to switch from DL reception to UL transmission and vice versa can be minimized.

The minimum switching time required by a UE from DL to UL is defined (3GPP TS 38.211, Clause 4.3.2) as N_{Rx_Tx}*T, where N_{Rx_Tx} is, for frequency range 1 (FR1), 25600, and is, for frequency range 2 (FR2), 13792. Incidentally, according to this definition, the minimum switching time required by a UE from UL to DL is N_{Tx_Rx}*T_{c} where N_{Tx_Rx} is, for FR1, 25600, and is, for FR2, 13792, as well.

A UE not capable of full-duplex communication is not expected to transmit in the uplink earlier than N_{Rx-Tx}T_{c} after the end of the last received downlink symbol in the same cell where N_{Rx-Tx} is as mentioned above.

A UE not capable of full-duplex communication is not expected to receive in the downlink earlier than N_{Tx-Rx}T_{c} after the end of the last transmitted uplink symbol in the same cell where N_{Tx-Rx} is as mentioned above.

For FR1, this leads to a switching time of about 13.03 us.

Use of the N_{TA,offset}>0 (25600*Tc=13.03 μs) to reduce the overhead due to UL-to-DL and UL-to-DL switching from two orthogonal frequency-division multiple access (OFDMA) symbols to one OFDMA symbol is illustrated in the examples of FIG. 9 (N_{TA,offset}>0) and FIG. 10 (N_{TA,offset}=0). Here, FIG. 9 (FIGS. 9a and 9b) is a schematic diagram illustrating an exemplary uplink-downlink timing, and in particular represents an UL-DL timing diagram for TDD operation with N_{TA}-Offset=13 μs. Further, FIG. 10 (FIGS. 10a and 10b) is a schematic diagram illustrating an exemplary uplink-downlink timing, and in particular represents an UL-DL timing diagram for TDD operation with no N_{TA}-Offset.

This assumes that the maximum propagation delay between gNB and UE is smaller or equal than (OS−N_{TA,offset}−N_{Rx-TX}T_{c})/2, where OS is the length of an OFDMA symbol. For a sub-carrier spacing (SCS) of 30 kHz, this corresponds to a maximum propagation delay of about 5 us, i.e. to a cell radius of ca. 1.5 km (or UE location must be within this range). For larger cell sizes, the overhead reduction is from n+1 to n OFDMA symbols, where n depends on the cell size.

When N_{TA,offset}>0, there may be Fast-Fourier Transform (FFT) time misalignment with SBFD between UL Rx and DL Tx when the gNB is simultaneously receiving in UL and transmitting in DL during SBFD slots. Not having the same subcarrier grid and symbol timing in DL and UL may result in increased cross-link interference (CLI) (gNB self-interference), or at least it makes it more difficult for the gNB to perform self-interference cancellation in digital domain.

In order to achieve time alignment between UL and DL signals at the gNB, it may be considered to use N_{TA,offset}=0.

However, this has two main limitations.

Namely, firstly, it increases the required overhead when switching from DL-to-UL and UL-to-DL (similar problem as outlined above with reference to FIG. 10).

Secondly, though in principle N_{TA,offset} can be configured by the network to any value among 0, 25600*Tc and 39936*Tc by parameter n-TimingAdvanceOffset, in practice, legacy UEs always assume the value specified in the table above (for the corresponding frequency range and co-existence scenario) independently of what the network indicates in system information.

Therefore, setting N_{TA,offset}=0 may lead to backward compatibility issues with legacy devices.

In view thereof, it might be considered to set two different values of N_{TA,offset} for SBFD slots and TDD slots. FIG. 11 (FIGS. 11a and 11b) is a schematic diagram illustrating an exemplary uplink-downlink timing, and in particular represents an UL-DL timing diagram for SBFD operation with N_{TA}-Offset=13 us in TDD (UL) slots and no N_{TA}-Offset (i.e. N_{TA}-Offset=0 us) in SBFD slots.

However, changing the TA offset from 0 us in SBFD slots to e.g. 13 us in TDD (UL) slots may cause an overlap between UL transmissions in the last symbol of the SBFD slot and in the first symbol of the TDD (UL) slot. Puncturing the UL transmission in (or rate match around) the last symbol of the SBFD slot would result in one additional symbol lost when switching between TDD (DL) to SBFD and then back to TDD (UL).

Hence, the problem arises that a secure, performant and resource preserving integration of subband non-overlapping full duplex is to be provided.

Hence, there is a need to provide for enhancement of uplink transmissions.

### SUMMARY

Various example embodiments aim at addressing at least part of the above issues and/or problems and drawbacks.

Various aspects of example embodiments are set out in the appended claims.

According to an exemplary aspect, there is provided a method of a terminal in a mobile network, the method comprising transmitting a first message indicative of the terminal's capability of half-symbol transmission, receiving a configuration for half-symbol transmission, and transmitting, based on said configuration, a signal in a part of a symbol located in a specific period between a first resource and a second resource.

According to an exemplary aspect, there is provided a method comprising receiving, from a terminal, a first message indicative of the terminal's capability of half-symbol transmission, preparing a configuration for half-symbol transmission based on said first message, and transmitting said configuration to said terminal.

According to an exemplary aspect, there is provided an apparatus of a terminal in a mobile network, the apparatus comprising transmitting circuitry configured to transmit a first message indicative of the terminal's capability of half-symbol transmission, and receiving circuitry configured to transmit a configuration for half-symbol transmission, wherein said transmitting circuitry is configured to transmit, based on said configuration, a signal in a part of a symbol located in a specific period between a first resource and a second resource.

According to an exemplary aspect, there is provided an apparatus comprising receiving circuitry configured to receive, from a terminal, a first message indicative of the terminal's capability of half-symbol transmission, preparing circuitry configured to prepare a configuration for half-symbol transmission based on said first message, and transmitting circuitry configured to transmit said configuration to said terminal.

According to an exemplary aspect, there is provided an apparatus of a terminal in a mobile network, the apparatus comprising at least one processor, at least one memory including computer program code, and at least one interface configured for communication with at least another apparatus, the at least one processor, with the at least one memory and the computer program code, being configured to cause the apparatus to perform transmitting a first message indicative of the terminal's capability of half-symbol transmission, receiving a configuration for half-symbol transmission, and transmitting, based on said configuration, a signal in a part of a symbol located in a specific period between a first resource and a second resource.

According to an exemplary aspect, there is provided an apparatus of a terminal in a mobile network, the apparatus comprising at least one processor, at least one memory including computer program code, and at least one interface configured for communication with at least another apparatus, the at least one processor, with the at least one memory and the computer program code, being configured to cause the apparatus to perform receiving, from a terminal, a first message indicative of the terminal's capability of half-symbol transmission, preparing a configuration for half-symbol transmission based on said first message, and transmitting said configuration to said terminal.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient utilization of radio resources also when applying SBFD to thereby solve at least part of the problems and drawbacks identified in relation to the prior art.

By way of example embodiments, there is provided enhancement of uplink transmissions. More specifically, by way of example embodiments, there are provided measures and mechanisms for realizing enhancement of uplink transmissions.

Thus, improvement is achieved by methods, apparatuses and computer program products enabling/realizing enhancement of uplink transmissions.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a schematic diagram of a procedure according to example embodiments,

FIG. 6 is a schematic diagram of a procedure according to example embodiments,

FIG. 7 is a schematic diagram of example duplex modes and respective resource partitioning,

FIG. 8 is a schematic diagram illustrating the timing advance,

FIG. 9 (FIGS. 9a and 9b) is a schematic diagram illustrating an exemplary uplink-downlink timing,

FIG. 10 (FIGS. 10a and 10b) is a schematic diagram illustrating an exemplary uplink-downlink timing,

FIG. 11 (FIGS. 11a and 11b) is a schematic diagram illustrating an exemplary uplink-downlink timing,

FIG. 12 (FIGS. 12a and 12b) is a schematic diagram illustrating an exemplary uplink-downlink timing according to example embodiments,

FIG. 13 is a schematic diagram of a procedure according to example embodiments, and

FIG. 14 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) enhancement of uplink transmissions.

Summarizing, low-complexity methods and mechanisms for half-symbol transmission in the beginning of an UL transmission burst is provided, targeting at reducing the overhead needed for DL-to-UL and UL-to-DL switching with SBFD operation requiring FFT alignment between UL Rx and DL Tx at the gNB (at least during SBFD slots).

The proposed methods and mechanisms rely on the UE utilizing the second part of a guard period (e.g., the second half of a guard period) for transmitting data on half the number of the sub-carriers within its allocated bandwidth (enabling half-OFDMA symbol transmission in the guard period between DL reception and UL transmission and/or between two consecutive UL transmissions using different TA offsets in SBFD) without burdening the gNB receiver with a separate FFT processing of the half symbol.

In the context of SBFD, a guard period is both:
a symbol or a part of a symbol used in the transition from DL transmission/reception in a TDD DL slot to UL reception/transmission in a SBFD slot, and
a symbol or a part of a symbol used in the transition from UL transmission/reception in SBFD slot to UL transmission/reception in a TDD UL slot.

By enabling half-OFDMA symbol transmission in the guard period, the number of unused resources during the transition between DL transmission/reception to UL reception/transmission can be reduced e.g. from 1 symbol to half a symbol. Therefore, a reduction in overhead and gain in UL or DL performance can be obtained.

When in the present specification it is referred to a specific guard symbol, this is intended to also include the more general guard period which may include a guard symbol or a part of a guard symbol.

The proposed methods and mechanisms further provide a solution targeted for SBFD operation with different values of N_{TA,offset} configured in different slots.

In brief, according to example embodiments, methods and mechanisms to leverage the UE capability for half symbol (half-OFDMA symbol, half-OFDM symbol, half-OS) transmission are provided.

On transmitter side, according to example embodiments, the UE constructs the half-OS with a duration of half the original orthogonal frequency-division multiplexing (OFDM) symbol occupying the same bandwidth, and transmits the half-OS in the second half of the original OFDM symbol without cyclic prefix (CP). As an option, based on network configuration, the UE may also perform half-OS transmission including CP.

On the receiver side (gNB), according to example embodiments, since the UE does not transmit in the first OFDM half symbol, there is no inter symbol interference in the second half symbol. As there is no CP, this eliminates the need for special FFT processing of the half symbol. In some cases, e.g. when the delay spread of the channel is large (e.g. 300 ns or more), it might be beneficial to have the CP, requiring the gNB to perform a separate FFT processing.

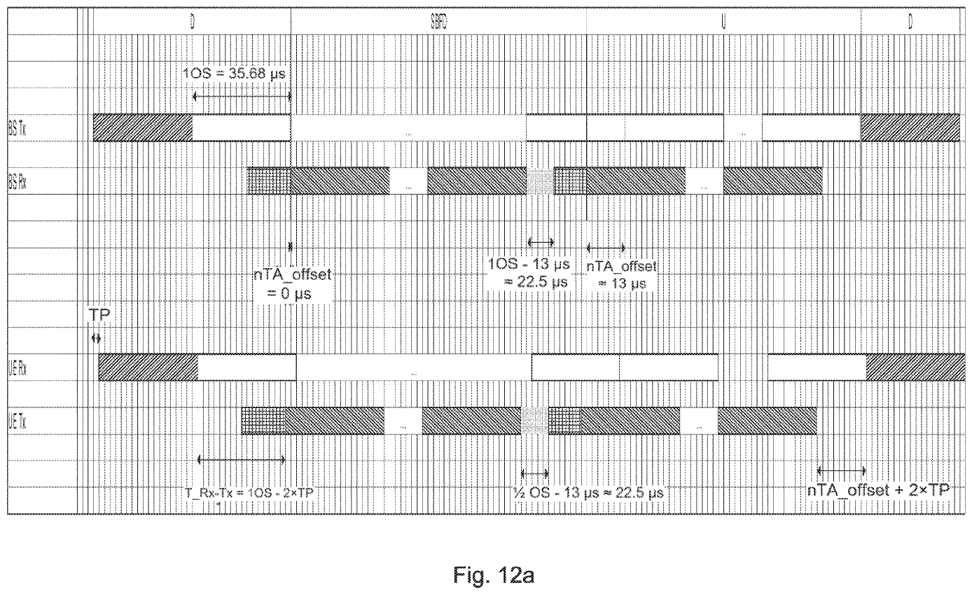

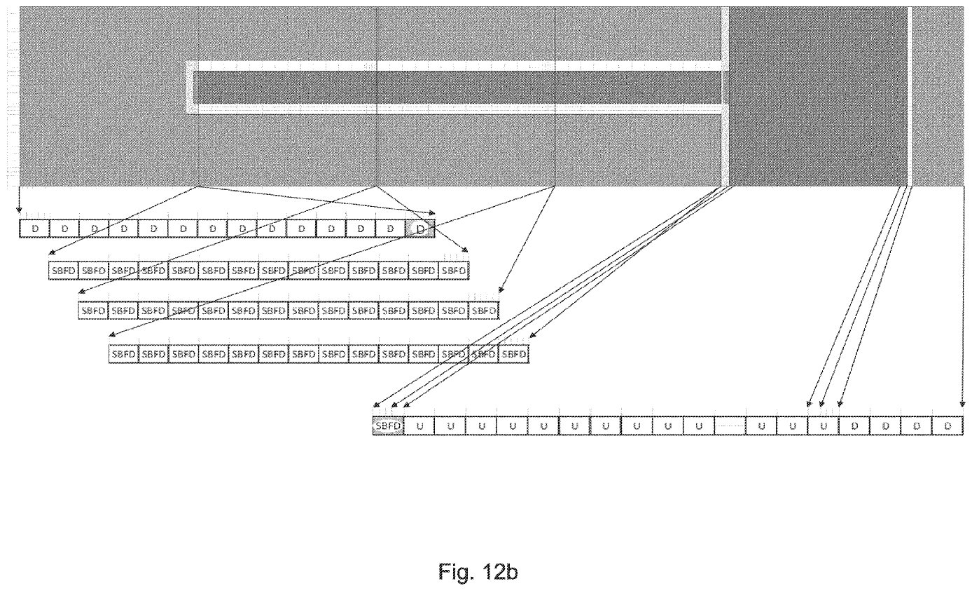

FIG. 12 (FIGS. 12a and 12b) is a schematic diagram illustrating an exemplary uplink-downlink timing according to example embodiments, and in particular represents an UL-DL timing diagram for SBFD operation with different N_{TA}-Offset in SBFD and TDD UL slots and with half-OS transmission enabled in the transition between TDD DL and SBFD slots and between SBFD and TDD UL slots.

According to example embodiments, the UE signals its half symbol transmission capability to the gNB, and the gNB utilizes this indication for UE configuration in relation to half symbol transmission. According to example embodiments, the UE configuration is effected utilizing radio resource control (RRC) configuration or utilizing downlink control information (DCI).

In particular, according to example embodiments, a UE capability signaling to the gNB is provided, indicating the ability to transmit on half of an OFDM symbol.

Further, according to example embodiments, the gNB uses this capability indication as a prerequisite to configure a new UE operation that relies on such capability.

Further, according to example embodiments, the gNB uses RRC configuration (e.g. 1 bit flag per serving cell or bandwidth part (BWP)) to instruct the UE to perform half-OS transmission in the start of an UL transmission when the UL transmission starts (as shown in FIG. 12)
in an SBFD slot immediately following a DL transmission in a TDD DL slot, or
in a TDD UL slot immediately following an UL transmission in a SBFD slot.

According to example embodiments, the instruction to perform half-OS transmission in the start of an UL transmission are signaled separately for the case that the UL transmission starts in an SBFD slot immediately following a DL transmission in a TDD DL slot and for the case that the UL transmission starts in a TDD UL slot immediately following an UL transmission in a SBFD slot. According to further example embodiments, the instruction to perform half-OS transmission in the start of an UL transmission are signaled in common for the two cases.

Alternatively or in addition, according to example embodiments, the gNB uses a 1 bit field in a DCI scheduling an UL transmission (e.g. DCI format 0_x scheduling physical uplink shared channel (PUSCH)) to indicate to the UE whether to apply the half-OS transmission in the first OFDM symbol of an UL transmission.

The RRC-based configuration may be more suitable for semi-statically configured UL transmissions such as e.g. configured grant physical uplink shared channel (CG-PUSCH) and sounding reference signals (SRS).

As an example, half-OS transmission may be configured for CG-PUSCH transmissions starting in the first SBFD slot immediately following a TDD DL slot, and/or for CG-PUSCH transmissions starting in (and/or spanning over) the first TDD UL slot immediately following an SBFD slot.

As a further example, a UE may be configured to transmit half-OS SRS in the OFDMA symbol preceding the first UL SBFD slot immediately following a TDD DL slot and/or in the OFDMA symbol preceding the first UL TDD slot immediately following a SBFD slot.

The DCI-based indication may be best suited for dynamically scheduled UL transmissions. Compared to use of RRC signaling, DCI-based indication provides more control to the gNB on when to apply or not to apply the new UE operation.

In case of DCI-based indication, other possibilities for the signaling are also possible, e.g. based on the radio network temporary identifier (RNTI) that is used to scramble the corresponding cyclic redundancy check (CRC) of the DCI. As an example, the half symbol transmission according to example embodiments is applied only in case the CRC of the DCI scheduling an UL transmission is scrambled with a specific (network-configured) RNTI (e.g. existing modulation coding scheme cell RNTI (MCS-C-RNTI), or a new RNTI defined for this purpose).

According to further example embodiments, the gNB receives dynamic support from the UE for the decision on whether to enable half-OS functionality in the transition from a TDD DL slot to an SBFD slot. In order for the UE to be able to perform half-OS transmission in the guard period between a DL reception and an UL transmission, the condition “(TA+N_{Rx}_{_{Tx}}*Tc)+half-OS duration<guard period” shall always be satisfied. However, the actual TA at the UE may not always be known at the gNB with absolute accuracy, requiring the UE to dynamically inform gNB whether the condition above is satisfied.

To achieve this, according to example embodiments, the UE dynamically reports (through uplink control information (UCI) or MAC CE) whether the condition “(TA+N_{Rx}_{_{Tx}}*Tc)+half-OS duration<guard period” is satisfied or not. In this case, a 1 bit flag would be enough for the reporting. Note that this embodiment may also be useful in case the gNB knows the actual TA used at the UE but the UE could be capable of performing Rx-Tx switching faster than what is specified in the minimum requirements (i.e. faster than N_{Rx}_{_{Tx}}*Tc).

Alternatively, according to example embodiments, the UE dynamically reports (through UCI or MAC-CE) the whole quantity TA+N_{Rx}_{_{Tx}}*Tc to allow the gNB to determine the length of the gap needed by the UE.

According to further example embodiments, the UE applies the half-OS transmission for cases where the first symbol allocated to an UL transmission is configured as an SBFD symbol AND it is the first or second SBFD symbol after a DL symbol, where whether it the first or second SBFD symbol after a DL symbol is configured by the network via RRC.

According to further example embodiments, the UE applies the half-OS transmission for cases where the first symbol allocated to an UL transmission is configured as an UL symbol AND it is the first UL symbol after a SBFD symbol AND the UL transmission is confined within frequency resources that were used for UL transmission in the SBFD symbol.

According to further example embodiments, one or more symbols for which the half-OS transmission is to be applied are explicitly indicated by the gNB.

Heretofore, a new system information block (SIB)/RRC signaling or an extension of “tdd-dl-ul-configCommon”, “tdd-dl-ul-configDedicated” RRC signaling or DCI 2_0 (slot format indicator (SFI)) is used. In principle, according to such example embodiments, the gNB indicates in advance to the UE the DL-UL switching points of the used TDD configuration.

While the above example embodiments focus on kind of a binary type of signaling (i.e., apply or not apply the half-OS symbol transmission), further example embodiments in addition include that the gNB can further instruct (i.e., further instructs) the UE whether to include the CP in the half-OS transmission (in other words, such functionality is combinable with any of the disclosed example embodiments). In such case, the gNB would do different FFT processing at the reception (for the half-OS symbol and for the other part of a transmission). In other words, according to such example embodiments, not two but three possible instructions could be indicated to the UE: i) apply the half-OS transmission, il) apply the half-OS transmission AND include CP, and ill) do not apply half-OS transmission. Hence, according to example embodiments, one additional bit is utilized in the signaling between gNB and UE to indicate inclusion/exclusion of the CP.

Example embodiments are specified below in more detail.

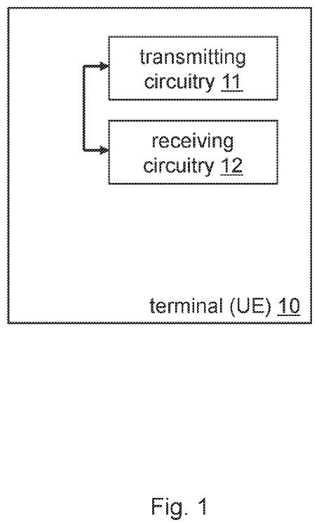

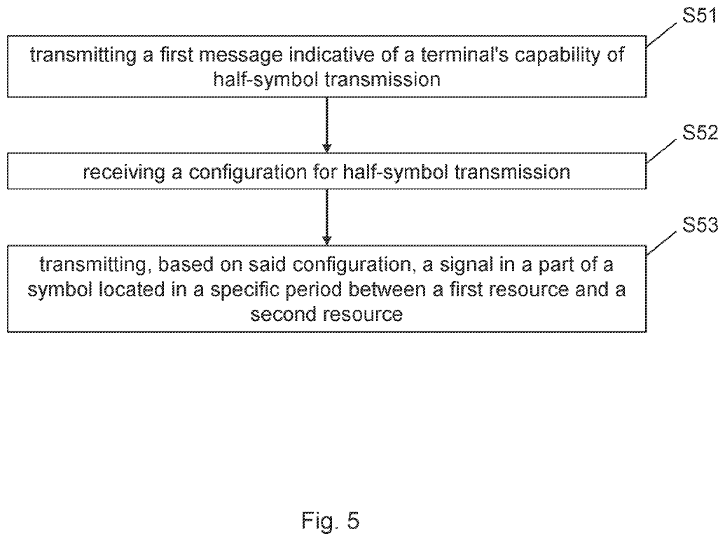

FIG. 1 is a block diagram illustrating an apparatus according to example embodiments. The apparatus may be a terminal 10 such as a user equipment (or a network entity embodying such functionality) comprising a transmitting circuitry 11, and a receiving circuitry 12. The transmitting circuitry 11 transmits a first message indicative of the terminal's capability of half-symbol transmission. The receiving circuitry 12 receives a configuration for half-symbol transmission. The transmitting circuitry 11 (or an additional transmitting circuitry) transmits, based on said configuration, a signal in a part of a symbol located in a specific period between a first resource and a second resource. FIG. 5 is a schematic diagram of a procedure according to example embodiments. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to example embodiments comprises an operation of transmitting (S51) a first message indicative of the terminal's capability of half-symbol transmission, an operation of receiving (S52) a configuration for half-symbol transmission, and an operation of transmitting (S53), based on said configuration, a signal in a part of a symbol located in a specific period between a first resource and a second resource.

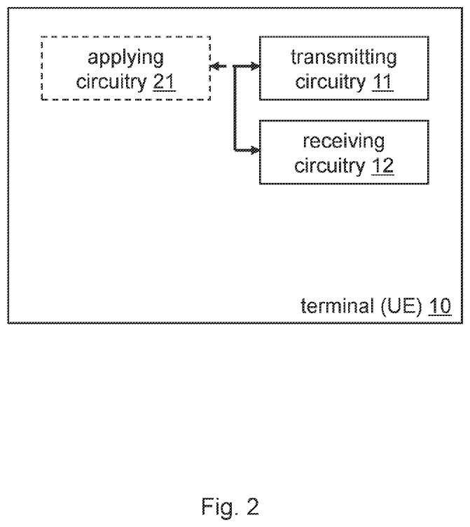

FIG. 2 is a block diagram illustrating an apparatus according to example embodiments. In particular, FIG. 2 illustrates a variation of the apparatus shown in FIG. 1. The apparatus according to FIG. 2 may thus further comprise an applying circuitry 21.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary additional operations are given, which are inherently independent from each other as such. According to such variation, an exemplary method according to example embodiments may comprise an operation of transmitting information in relation to a timing advance at the terminal.

According to further example embodiments, said information in relation to said timing advance at the terminal includes at least one of said timing advance at the terminal, a sum of said timing advance at the terminal and a terminal minimum downlink-uplink switching time, and an indication that a condition that a sum of said timing advance at the terminal, said terminal minimum downlink-uplink switching time, and a duration of said signal in said specific period is smaller than a duration of said specific period is fulfilled.

According to a variation of the procedure shown in FIG. 5, exemplary additional operations are given, which are inherently independent from each other as such. According to such variation, an exemplary method according to example embodiments may comprise an operation of receiving an instruction to report said information in relation to said timing advance at the terminal.

According to further example embodiments, said configuration includes radio resource configuration indicative of a type of said first resource and a type of said second resource.

According to further example embodiments, said radio resource configuration is indicative of a type of a third resource following said second resource.

According to further example embodiments, said configuration includes downlink control information scheduling an uplink transmission and being indicative of whether to apply half-symbol transmission for said uplink transmission.

According to further example embodiments, said configuration is indicative of a symbol for which half-symbol transmission is to be applied.

According to further example embodiments, said configuration is included in a system information block. Alternatively, according to further example embodiments, said configuration is included in a radio resource configuration.

According to a variation of the procedure shown in FIG. 5, exemplary additional operations are given, which are inherently independent from each other as such, According to such variation, said configuration is indicative of whether to apply a cyclic prefix to said signal in said specific period, and an exemplary method according to example embodiments may comprise an operation of applying, in case said configuration is indicative of that said cyclic prefix is to be applied to said signal in said specific period, said cyclic prefix to said signal in said specific period.

According to further example embodiments, said first resource is a downlink resource.

According to further example embodiments, said first resource is a sub-band non-overlapping full duplex resource.

According to further example embodiments, said second resource is an uplink resource.

According to further example embodiments, said second resource is a sub-band non-overlapping full duplex resource.

According to further example embodiments, said part of said specific period is a second half of said specific period.

According to further example embodiments, said terminal's capability of half-symbol transmission is associated with a band or band combination.

According to further example embodiments, said specific period is a guard period including at least a part of a guard symbol.

According to further example embodiments, in a case that, for a scheduled uplink transmission, a sum of a timing advance at the terminal, a terminal minimum downlink-uplink switching time, and a duration of said signal in a first specific period as said specific period is not smaller than a duration of said first specific period, said signal is transmitted in a part of a symbol located in a second specific period as said specific period following said first specific period. According to example embodiments, the first specific period may be a guard period. According to further example embodiments, the second specific period may be a subband non-overlapping full duplex symbol or an uplink symbol respectively following the guard period.

According to a variation of the procedure shown in FIG. 5, exemplary additional operations are given, which are inherently independent from each other as such. According to such variation, an exemplary method according to example embodiments may comprise an operation of receiving a condition configuration defining receipt of said configuration for half-symbol transmission as a condition for application of said half-symbol transmission.

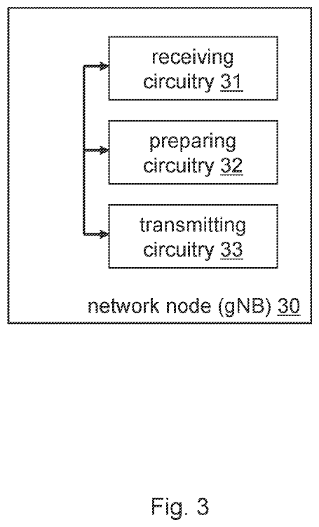

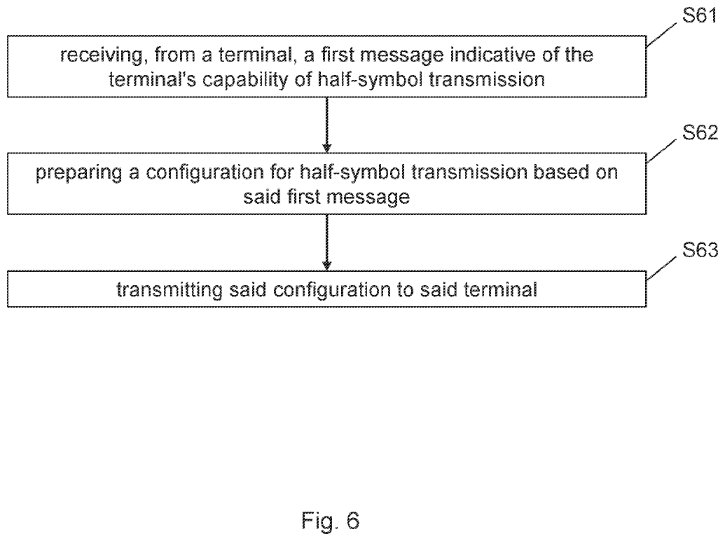

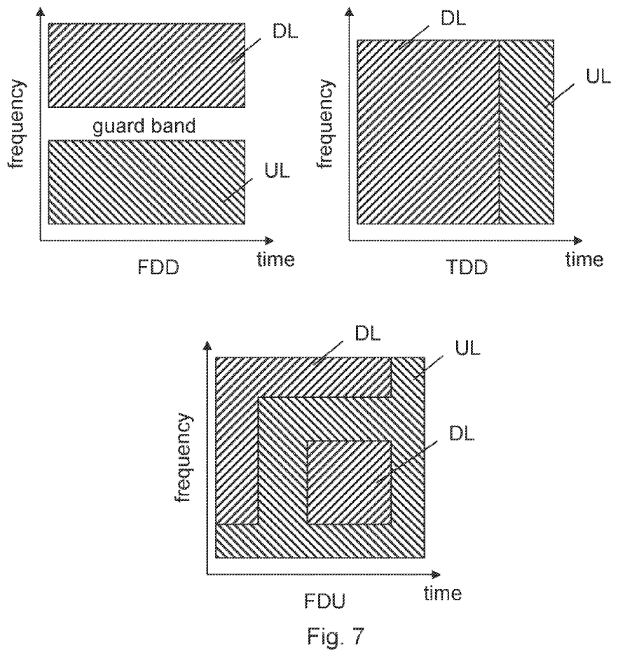

FIG. 3 is a block diagram illustrating an apparatus according to example embodiments. The apparatus may be a network node 30 such as a base station (or a network entity embodying such functionality) comprising a receiving circuitry 31, a preparing circuitry 32, and a transmitting circuitry 33. The receiving circuitry 31 receives, from a terminal, a first message indicative of the terminal's capability of half-symbol transmission. The preparing circuitry 32 prepares a configuration for half-symbol transmission based on said first message. The transmitting circuitry 33 transmits said configuration to said terminal. FIG. 6 is a schematic diagram of a procedure according to example embodiments. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to example embodiments comprises an operation of receiving (S61), from a terminal, a first message indicative of the terminal's capability of half-symbol transmission, an operation of preparing (S62) a configuration for half-symbol transmission based on said first message, and an operation of transmitting (S63) said configuration to said terminal.

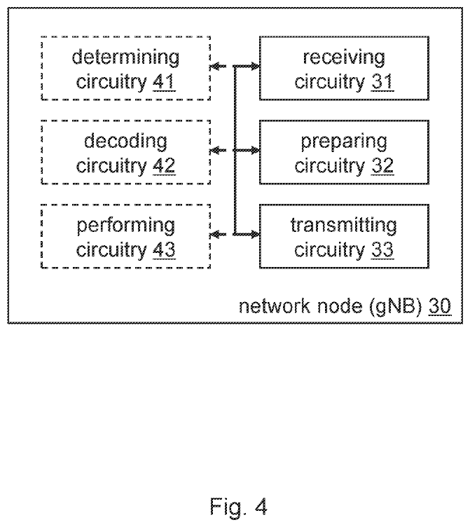

FIG. 4 is a block diagram illustrating an apparatus according to example embodiments. In particular, FIG. 4 illustrates a variation of the apparatus shown in FIG. 3. The apparatus according to FIG. 4 may thus further comprise a determining circuitry 41, a decoding circuitry 42, and/or a performing circuitry 43.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary additional operations are given, which are inherently independent from each other as such. According to such variation, an exemplary method according to example embodiments may comprise an operation of receiving information in relation to a timing advance at the terminal. Here, said preparing is based on said information.

According to a variation of the procedure shown in FIG. 6, exemplary additional operations are given, which are inherently independent from each other as such. According to such variation, said information in relation to said timing advance at the terminal includes said timing advance at the terminal, or a sum of said timing advance at the terminal and a terminal minimum downlink-uplink switching time, and an exemplary method according to example embodiments may comprise an operation of determining, based on said information, whether a condition that a sum of said timing advance at the terminal, said terminal minimum downlink-uplink switching time, and a duration of said signal in said specific period is smaller than a duration of said specific period is fulfilled.

According to further example embodiments, said information in relation to said timing advance at the terminal is indicative of whether a condition that a sum of said timing advance at the terminal, a terminal minimum downlink-uplink switching time, and a duration of a signal in a specific period between a first resource and a second resource is smaller than a duration of said specific period is fulfilled.

According to a variation of the procedure shown in FIG. 6, exemplary additional operations are given, which are inherently independent from each other as such. According to such variation, an exemplary method according to example embodiments may comprise an operation of transmitting an instruction to report said information in relation to a timing advance at the terminal.

According to a variation of the procedure shown in FIG. 6, exemplary additional operations are given, which are inherently independent from each other as such. According to such variation, an exemplary method according to example embodiments may comprise an operation of receiving, from said terminal, a signal in a part of a symbol located in said specific period.

According to a variation of the procedure shown in FIG. 6, exemplary additional operations are given, which are inherently independent from each other as such. According to such variation, an exemplary method according to example embodiments may comprise an operation of decoding said signal.

According to further example embodiments, said configuration includes radio resource configuration indicative of a type of said first resource and a type of said second resource.

According to further example embodiments, said radio resource configuration is indicative of a type of a third resource following said second resource.

According to further example embodiments, said configuration includes downlink control information scheduling an uplink transmission and being indicative of whether to apply half-symbol transmission for said uplink transmission.

According to further example embodiments, said configuration is indicative of a symbol for which half-symbol transmission is to be applied.

According to further example embodiments, said configuration is included in a system information block. Alternatively, according to further example embodiments, said configuration is included in a radio resource configuration.

According to a variation of the procedure shown in FIG. 6, exemplary additional operations are given, which are inherently independent from each other as such. According to such variation, said configuration is indicative of whether to apply a cyclic prefix to said signal in said specific period, and an exemplary method according to example embodiments may comprise an operation of performing, in case said configuration is indicative of that said cyclic prefix is to be applied to said signal in said specific period, a Fast Fourier Transform preparation processing of removing said cyclic prefix from said signal in said specific period.

According to further example embodiments, said specific period is a guard period including at least a part of a guard symbol.

According to further example embodiments, said configuration is indicative of that, in a case that, for a scheduled uplink transmission, a sum of a timing advance at the terminal, a terminal minimum downlink-uplink switching time, and a duration of a signal in a first specific period as said specific period is not smaller than a duration of said first specific period, half-symbol transmission is to be applied to a second specific period as said specific period following said first specific period. According to example embodiments, the first specific period may be a guard period. According to further example embodiments, the second specific period may be a subband non-overlapping full duplex symbol or an uplink symbol respectively following the guard period.

According to further example embodiments, said first resource is a downlink resource.

According to further example embodiments, said first resource is a sub-band non-overlapping full duplex resource.

According to further example embodiments, said second resource is an uplink resource.

According to further example embodiments, said second resource is a sub-band non-overlapping full duplex resource.

According to further example embodiments, said part of said specific period is a second half of said specific period.

According to further example embodiments, said terminal's capability of half-symbol transmission is associated with a band or band combination.

According to a variation of the procedure shown in FIG. 6, exemplary additional operations are given, which are inherently independent from each other as such. According to such variation, an exemplary method according to example embodiments may comprise an operation of transmitting a condition configuration defining receipt of said configuration for half-symbol transmission as a condition for application of said half-symbol transmission.

Example embodiments outlined and specified above are explained below in more specific terms.

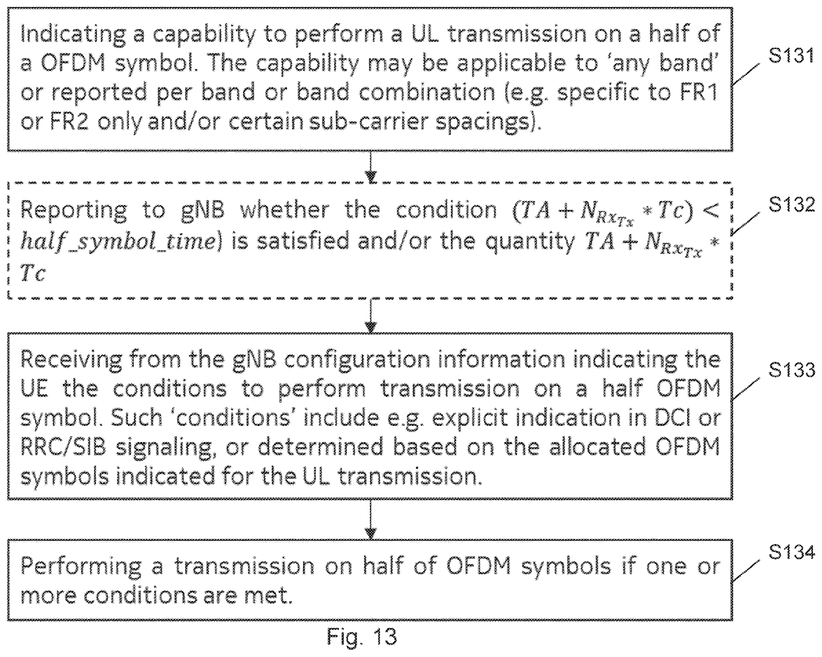

FIG. 13 is a schematic diagram of a procedure according to example embodiments, and in particular illustrates an example UE operation according to example embodiments.

FIG. 13 illustrates a concrete example of a UE operation in line with example embodiments outlined in brief above.

In the example UE operation according to example embodiments, in a step S131, the UE indicates a capability to perform an uplink transmission on a half of an OFDM symbol. The capability may be applicable to “any band”, or may be reported per band of band combination.

In order for the half-OS functionality to be applicable at the UE side in the transition from DL slot to SBFD slot, the TA at the UE shall not exceed a certain value, i.e. (TA+N_{Rx}_{_{Tx}}*Tc)+half-OS duration<guard period”.

The TA is signaled by the gNB to the UE, but the UE may also apply some autonomous adjustments to the TA.

Hence, in the example UE operation according to example embodiments, in a step S132, the UE reports whether the condition “(TA+N_{Rx}_{_{Tx}}*Tc)+half-OS duration<guard period” (or alternatively the condition “(TA+N_{Rx}_{_{Tx}}*Tc)<half_symbol_time”) is satisfied, and/or reports the quantity “(TA+N_{Rx}_{_{Tx}}*Tc)+half-OS duration (or alternatively the quantity TA+N_{Rx}_{_{Tx}}*TC).

Depending on the gNB implementation, the gNB may know the TA applied at the UE, in which case the reporting of the condition “(TA+N_{Rx}_{_{Tx}}*Tc)+half-OS duration<guard period” from the UE to gNB is not needed (since the gNB has all the information it needs to calculate by itself). Thus, in the example UE operation according to example embodiments, step S132 is indicated as optional.

In case the gNB does not know the actual TA applied at the UE, according to example embodiments, the UE is configured or instructed to report to the gNB TA-related information.

In the example UE operation according to example embodiments, in a step S133, the UE receives configuration information indicating the UE conditions to perform transmission on a half OFDM symbol.

The “conditions” for applying the half-OS functionality are described above, which include
i) RRC signaling (e.g. 1 bit flag per serving cell or BWP),
ii) bit field in a DCI scheduling an UL transmission (e.g. DCI format 0_x scheduling PUSCH),
iii) explicit indication of the UL-DL switching points via extensions to tdd-dl-ul-configCommon, tdd-dl-ul-configDedicated RRC signaling and/or SFI signaling in DCI 2_0, or
iv) a result of a determination based on the allocated symbols for UL transmission with regard to UL/DL/flexible semi-static TDD symbols.

In the example UE operation according to example embodiments, in a step S134, the UE performs a transmission on half of OFDM symbols if one or more conditions are met.

According to example embodiments, the gNB instructs the UE to perform half-OS transmission in the first symbol of an UL transmission starting in the SBFD slot immediately following a TDD DL slot e.g. in case the indicated UL transmission (e.g. physical uplink control channel (PUCCH)/PUSCH/SRS) would not meet restrictions specified in 3GPP TS 38.211, Clause 4.3.2, if full OS transmission would be applied.

Therefore, according to example embodiments, a higher-layer parameter (e.g. “halfOS-Tx”) may be specified (as a configuration to perform half-OS transmission) and, in case, provided to a UE.

For such case, according to example embodiments, it may be specified/foreseen that a UE not capable of full-duplex communication is not expected to transmit in the uplink earlier than NRx-TxTc after the end of the last received downlink symbol in the same cell where NRx-Tx is given by Table 4.3.2-3 of 3GPP TS 38.211 (25600 for FR1, 13792 for FR2). If the UE is provided with the higher-layer parameter “halfOS-Tx” and is instructed to perform an uplink transmission that would not comply with the transition time N_{Rx-Tx}, the UE performs half OFDM symbol transmission in the first OFDM symbol of the transmission.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network node/entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

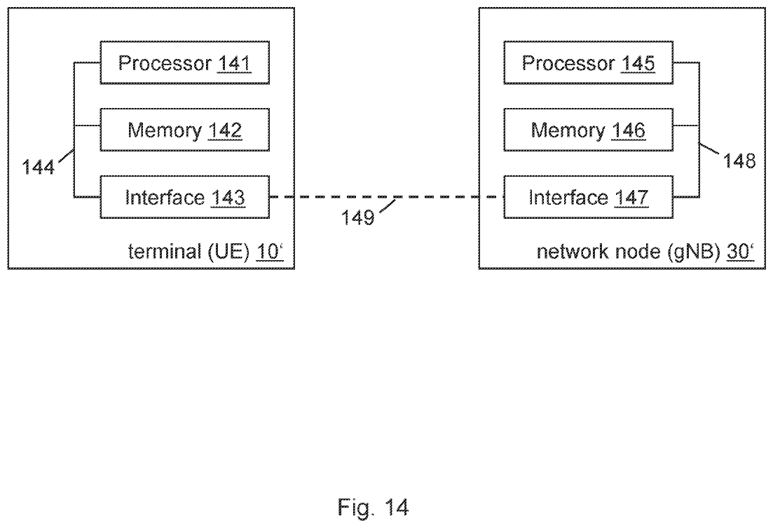

In FIG. 14, an alternative illustration of apparatuses according to example embodiments is depicted. As indicated in FIG. 14, according to example embodiments, the apparatus (terminal) 10′ (corresponding to the terminal 10) comprises a processor 141, a memory 142 and an interface 143, which are connected by a bus 144 or the like. Further, according to example embodiments, the apparatus (network node) 30′ (corresponding to the network node 30) comprises a processor 145, a memory 146 and an interface 147, which are connected by a bus 148 or the like, and the apparatuses may be connected via link 149, respectively.

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e. the interface thereof.

The memory 142/146 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the terminal 10 comprises at least one processor 141, at least one memory 142 including computer program code, and at least one interface 143 configured for communication with at least another apparatus. The processor (i.e. the at least one processor 141, with the at least one memory 142 and the computer program code) is configured to perform transmitting a first message indicative of the terminal's capability of half-symbol transmission (thus the apparatus comprising corresponding means for transmitting), to perform receiving a configuration for half-symbol transmission (thus the apparatus comprising corresponding means for receiving), and to perform transmitting, based on said configuration, a signal in a part of a symbol located in a specific period between a first resource and a second resource.

According to example embodiments, an apparatus representing the network node 30 comprises at least one processor 145, at least one memory 146 including computer program code, and at least one interface 147 configured for communication with at least another apparatus. The processor (i.e. the at least one processor 145, with the at least one memory 146 and the computer program code) is configured to perform receiving, from a terminal, a first message indicative of the terminal's capability of half-symbol transmission (thus the apparatus comprising corresponding means for receiving), to perform preparing a configuration for half-symbol transmission based on said first message (thus the apparatus comprising corresponding means for preparing), and to perform transmitting said configuration to said terminal (thus the apparatus comprising corresponding means for transmitting).

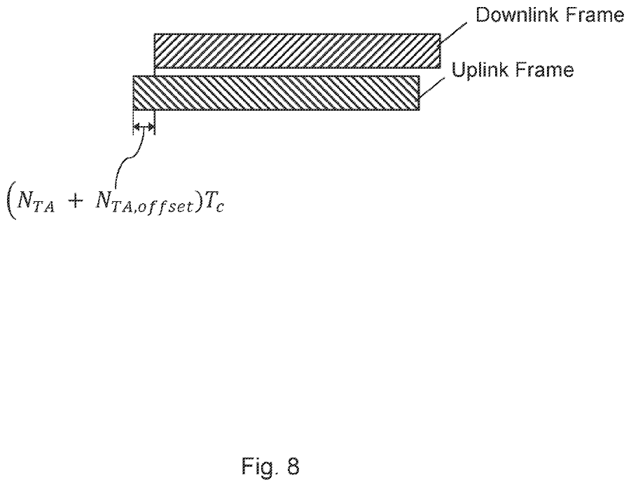

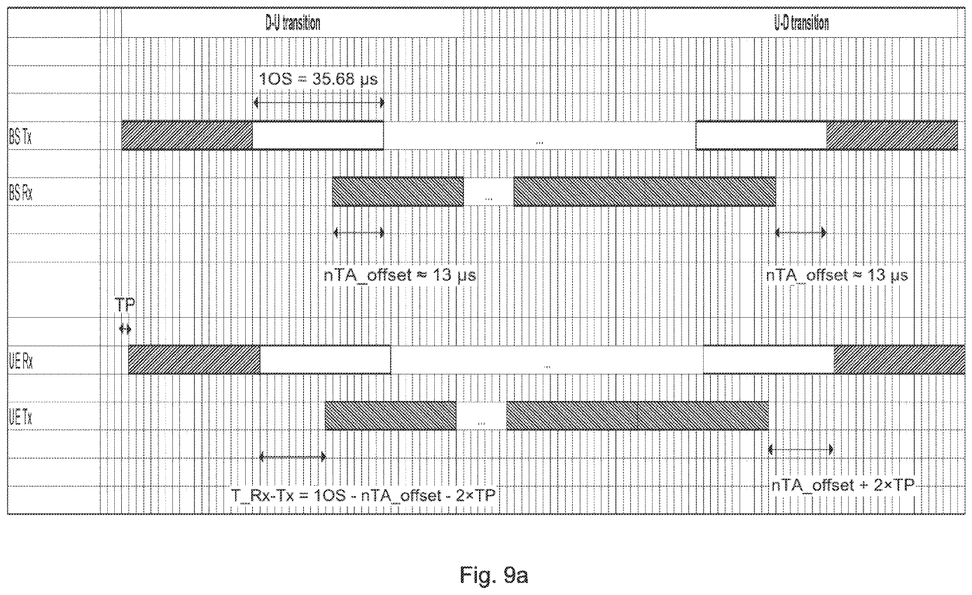

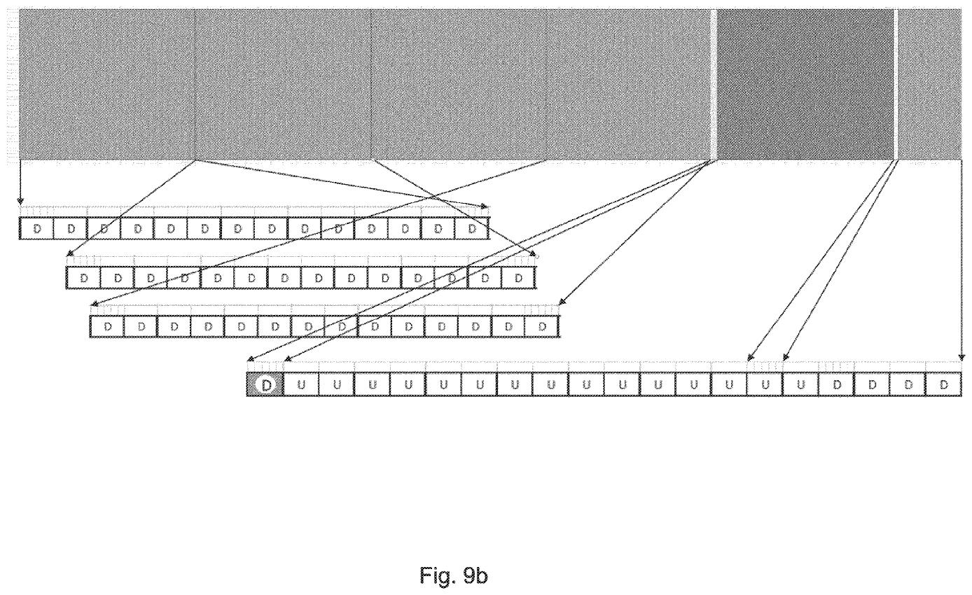

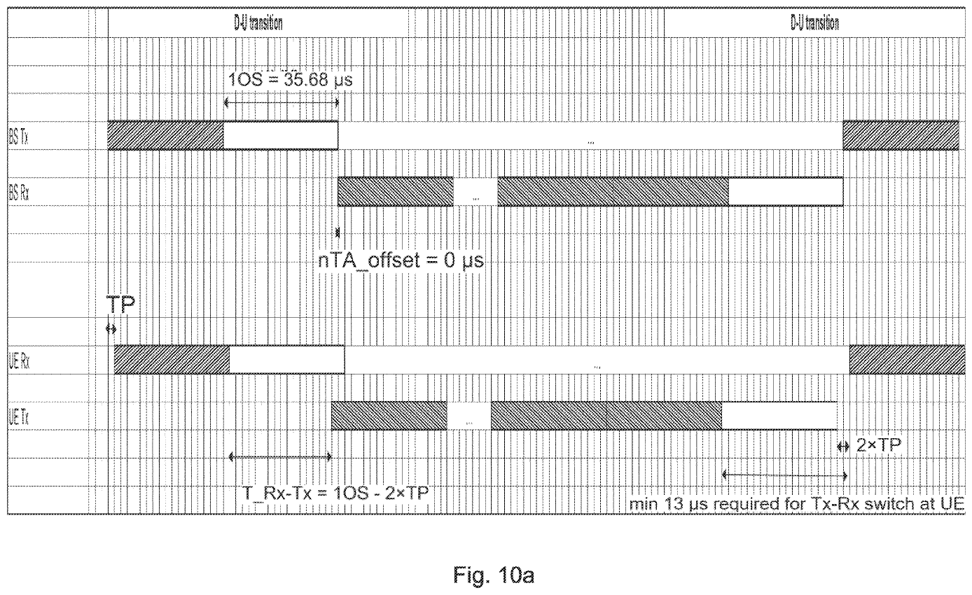

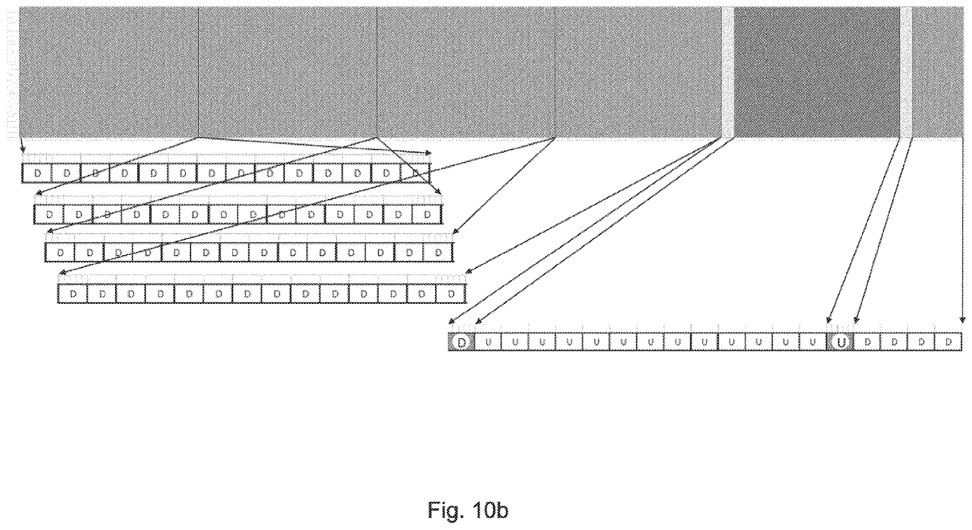

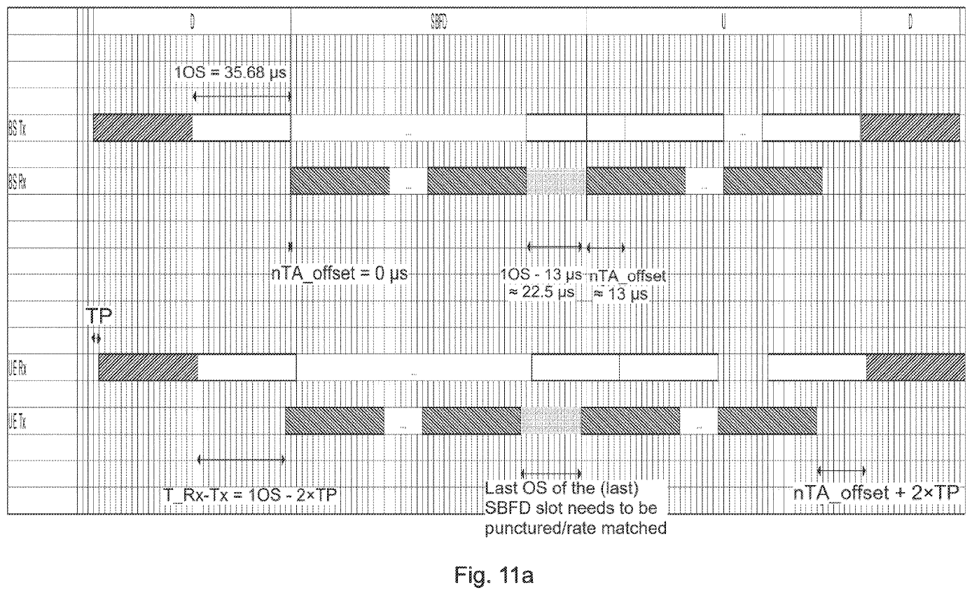

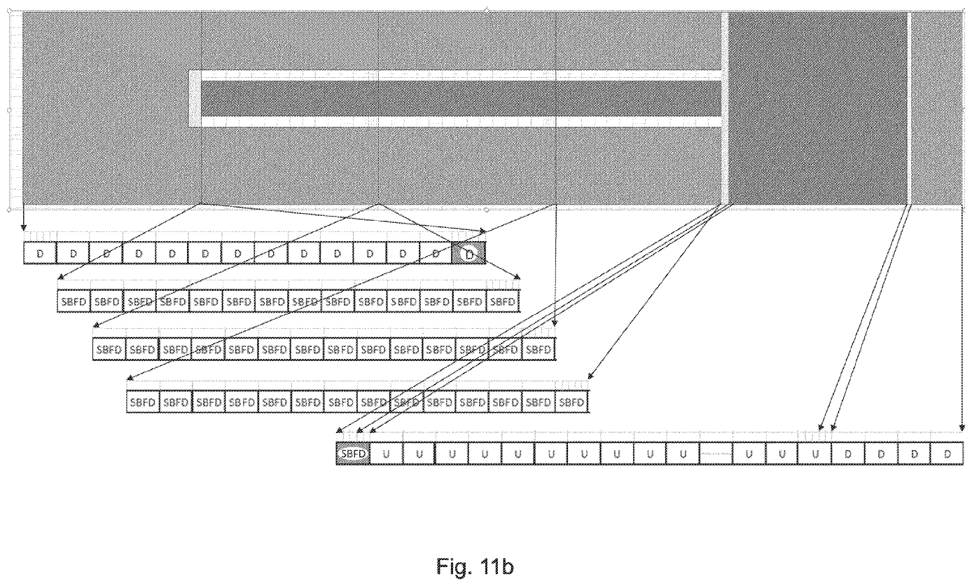

For further details regarding the operability/functionality of the individual apparatuses, reference is made to the above description in connection with any one of FIGS. 1 to 13, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BIMOS (Bipolar MOS), BICMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enhancement of uplink transmissions. Such measures exemplarily comprise, at a terminal, transmitting a first message indicative of the terminal's capability of half-symbol transmission, receiving a configuration for half-symbol transmission, and transmitting, based on said configuration, a signal in a part of a symbol located in a specific period between a first resource and a second resource.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

List of acronyms and abbreviations

| | |
|---|---|
| 3GPP | 3rd Generation Partnership Project |
| BWP | bandwidth part |
| CLI | cross-link interference |
| CG-PUSCH | configured grant PUSCH |
| CP | cyclic prefix |
| CRC | cyclic redundancy check |
| DCI | downlink control information |
| DL | downlink |
| FDD | frequency division duplex |
| FDU | flexible duplexing |
| FFT | Fast-Fourier Transform |
| FR1 | frequency range 1 |
| FR2 | frequency range 2 |
| MAC CE | medium access control control element |
| MCS-C-RNTI | modulation coding scheme cell RNTI |
| NR | New Radio |
| OFDM | orthogonal frequency-division multiplexing |
| OFDMA | orthogonal frequency-division multiple access |
| PRB | physical resource block |
| PUCCH | physical uplink control channel |
| PUSCH | physical uplink shared channel |
| RAR | random access response |
| RNTI | radio network temporary identifier |
| RRC | radio resource control |
| Rx | reception |
| SBFD | subband non-overlapping full duplex |
| SCS | sub-carrier spacing |
| SFI | slot format indicator |
| SIB | system information block |
| SIB1 | system information block 1 |
| SRS | sounding reference signal |
| TA | timing advance |
| TDD | time division duplex |
| Tx | transmission |
| UCI | uplink control information |
| UE | user equipment |
| UL | uplink |
| xDD | cross-division duplexing |

1.-101. (canceled)

102. A method of a terminal in a mobile network, the method comprising
transmitting a first message indicative of the terminal's capability of half-symbol transmission;
based on transmitting the first message indicative of the terminal's capability of half-symbol transmission, receiving a configuration for half-symbol transmission, the configuration being indicative of whether to apply a cyclic prefix to a signal in a specific period, and wherein the configuration includes downlink control information scheduling an uplink transmission and an indication to apply half-symbol transmission for the uplink transmission;
based on the configuration being indicative of that the cyclic prefix is to be applied to the signal in the specific period, applying the cyclic prefix to the signal in the specific period; and
transmitting, based on the configuration, the signal in a part of a symbol located in the specific period, the specific period being between a first resource and a second resource, the signal comprising information in relation to a timing advance at the terminal, the information comprising: the timing advance at the terminal, a sum of the timing advance at the terminal and a terminal minimum downlink-uplink switching time, and an indication that a condition that the sum of the timing advance at the terminal, the terminal minimum downlink-uplink switching time, and a duration of the signal in the specific period is smaller than a duration of the specific period is fulfilled, wherein the first resource is a downlink resource and a sub-band non-overlapping full duplex resource; the second resource is an uplink resource and a sub-band non-overlapping full duplex resource, and the part of the specific period is a second half of the specific period, and wherein the transmitting further comprises:
transmitted in a part of the symbol located in a second specific period as the specific period following the first specific period based on the following for a scheduled uplink transmission: a sum of a timing advance at the terminal, a terminal minimum downlink-uplink switching time, and a duration of the signal in a first specific period as the specific period is not smaller than a duration of the first specific period.

103. The method according to claim 102, further comprising:
receiving an instruction to report said information in relation to said timing advance at the terminal.

104. The method according to claim 103, wherein the configuration includes radio resource configuration indicative of a type of the first resource and a type of the second resource.

105. The method according to claim 104, wherein the radio resource configuration is indicative of a type of a third resource following the second resource.

106. The method according to claim 105, wherein the configuration is included in a system information block, or the configuration is included in a radio resource configuration.

107. The method according to claim 106, wherein the terminal's capability of half-symbol transmission is associated with a band or band combination; and wherein the specific period is a guard period including at least a part of a guard symbol.

108. The method according to claim 107, further comprising:
receiving a condition configuration defining receipt of the configuration for half-symbol transmission as a condition for application of the half-symbol transmission.

109. An apparatus of a terminal in a mobile network, the apparatus comprising;
transmitting circuitry configured to transmit a first message indicative of the terminal's capability of half-symbol transmission;
receiving circuitry configured to receive a configuration for half-symbol transmission;
a processor; and
a memory comprising computer-executable instructions that, when executed by the processor, cause the apparatus to perform the following operations:
transmitting the first message indicative of the terminal's capability of half-symbol transmission;
based on transmitting the first message indicative of the terminal's capability of half-symbol transmission, receiving the configuration for half-symbol transmission, the configuration being indicative of whether to apply a cyclic prefix to a signal in a specific period, and wherein the configuration includes downlink control information scheduling an uplink transmission and an indication to apply half-symbol transmission for the uplink transmission;
based on the configuration being indicative of that the cyclic prefix is to be applied to the signal in the specific period, applying the cyclic prefix to the signal in the specific period; and
transmitting, based on the configuration, the signal in a part of a symbol located in the specific period, the specific period being between a first resource and a second resource, the signal comprising information in relation to a timing advance at the terminal, the information comprising: the timing advance at the terminal, a sum of the timing advance at the terminal and a terminal minimum downlink-uplink switching time, and an indication that a condition that the sum of the timing advance at the terminal, the terminal minimum downlink-uplink switching time, and a duration of the signal in the specific period is smaller than a duration of the specific period is fulfilled, wherein the first resource is a downlink resource and a sub-band non-overlapping full duplex resource; the second resource is an uplink resource and a sub-band non-overlapping full duplex resource, and the part of the specific period is a second half of the specific period, and wherein the transmitting further comprises:
transmitted in a part of the symbol located in a second specific period as the specific period following the first specific period based on the following for a scheduled uplink transmission: a sum of a timing advance at the terminal, a terminal minimum downlink-uplink switching time, and a duration of the signal in a first specific period as the specific period is not smaller than a duration of the first specific period.

110. The apparatus according to claim 109, wherein the computer-executable instructions, when executed by the processor, further cause the apparatus to perform the following operation:
receiving an instruction to report said information in relation to said timing advance at the terminal.

111. The apparatus according to claim 110, wherein the configuration includes radio resource configuration indicative of a type of the first resource and a type of the second resource.

112. The apparatus according to claim 111, wherein the radio resource configuration is indicative of a type of a third resource following the second resource.

113. The apparatus according to claim 112, wherein the configuration is included in a system information block, or the configuration is included in a radio resource configuration.

114. The apparatus according to claim 113, wherein the terminal's capability of half-symbol transmission is associated with a band or band combination; and wherein the specific period is a guard period including at least a part of a guard symbol.

115. The apparatus according to claim 114, wherein the computer-executable instructions, when executed by the processor, further cause the apparatus to perform the following operation:
receiving a condition configuration defining receipt of the configuration for half-symbol transmission as a condition for application of the half-symbol transmission.

116. A system comprising:
an apparatus of a terminal in a mobile network, the apparatus comprising;
transmitting circuitry configured to transmit a first message indicative of the terminal's capability of half-symbol transmission;
receiving circuitry configured to receive a configuration for half-symbol transmission;
a processor; and
a memory comprising computer-executable instructions that, when executed by the processor, cause the apparatus to perform the following operations:
transmitting the first message indicative of the terminal's capability of half-symbol transmission;
based on transmitting the first message indicative of the terminal's capability of half-symbol transmission, receiving the configuration for half-symbol transmission, the configuration being indicative of whether to apply a cyclic prefix to a signal in a specific period, and wherein the configuration includes downlink control information scheduling an uplink transmission and an indication to apply half-symbol transmission for the uplink transmission;
based on the configuration being indicative of that the cyclic prefix is to be applied to the signal in the specific period, applying the cyclic prefix to the signal in the specific period; and
transmitting, based on the configuration, the signal in a part of a symbol located in the specific period, the specific period being between a first resource and a second resource, the signal comprising information in relation to a timing advance at the terminal, the information comprising: the timing advance at the terminal, a sum of the timing advance at the terminal and a terminal minimum downlink-uplink switching time, and an indication that a condition that the sum of the timing advance at the terminal, the terminal minimum downlink-uplink switching time, and a duration of the signal in the specific period is smaller than a duration of the specific period is fulfilled, wherein the first resource is a downlink resource and a sub-band non-overlapping full duplex resource; the second resource is an uplink resource and a sub-band non-overlapping full duplex resource, and the part of the specific period is a second half of the specific period, and wherein the transmitting further comprises:
transmitted in a part of the symbol located in a second specific period as the specific period following the first specific period based on the following for a scheduled uplink transmission: a sum of a timing advance at the terminal, a terminal minimum downlink-uplink switching time, and a duration of the signal in a first specific period as the specific period is not smaller than a duration of the first specific period.

117. The system according to claim 116, wherein the computer-executable instructions, when executed by the processor, further cause the apparatus to perform the following operation:
receiving an instruction to report said information in relation to said timing advance at the terminal.

118. The system according to claim 117, wherein the configuration includes radio resource configuration indicative of a type of the first resource and a type of the second resource.

119. The system according to claim 118, wherein the radio resource configuration is indicative of a type of a third resource following the second resource.

120. The system according to claim 119, wherein the configuration is included in a system information block, or the configuration is included in a radio resource configuration.

121. The system according to claim 120, wherein the terminal's capability of half-symbol transmission is associated with a band or band combination; wherein the specific period is a guard period including at least a part of a guard symbol; and wherein the computer-executable instructions, when executed by the processor, further cause the apparatus to perform the following operation:
receiving a condition configuration defining receipt of the configuration for half-symbol transmission as a condition for application of the half-symbol transmission.
